(19) United States
(12) Patent Application Publication
(10) Pub. No.: US 2015/0286029 A1
(43) Pub. Date: Oct. 8, 2015

(54) REFLECTOR SUPPORTS AND METHODS OF MANUFACTURE

(71) Applicants: Bernard Robert NASR, Hamilton (NZ); Kerry Allan HAYES, Hamilton (NZ); Tiger Profiles and Insulations LLC, Sharjah (AE)

(72) Inventors: Bernard Robert Nasr, Hamilton (NZ); Kerry Allan Hayes, Hamilton (NZ)

(21) Appl. No.: 14/434,713

(22) PCT Filed: Sep. 9, 2013
(86) PCT No.: PCT/NZ2013/000165

§ 371 Date: Apr. 9, 2015

(30) Foreign Application Priority Data
Oct. 9, 2012 (NZ) 602345

(51) Int. Cl. G02B 7/183; G02B 5/09

(52) U.S. Cl. CPC G02B 7/183; G02B 5/09

(57) ABSTRACT

This invention relates to a reflector support deck, including at least one corrugated sheet of material having two or more ridges of differing heights, characterised in that the ridges are positioned relative to each other so that the crests of the ridges collectively define a curved bearing surface that curves along a single axis.

### TECHNICAL FIELD

The present invention relates to improvements to reflector supports and methods of manufacture.

### BACKGROUND ART

Solar power generation is a rapidly developing industry due to the increasing costs of fossil fuels and greenhouse effect. Therefore considerable effort is being spent on renewable energy sources.

One efficient and cost effective form of solar power station is known as a Linear Fresnel Reflector (“LFR”). Of LFR power stations, the Compact Linear Fresnel Reflector power stations (“CLFR”) are particularly important as they produce more power than a LFR power station having a comparable area.

LFR and CLFR power stations both use arrays of mirrors to focus and concentrate sunlight onto absorbers containing a liquid having a high heat capacity. The sunlight transfers heat into the liquid, increasing its temperature causing it to change phase. The resulting gas is then passed through a heat inverter, and the extracted heat is used to power a steam generator.

The difference between LFRs and CLFRs is the arrangement of the mirrors, with CLFRs having more reflectors, which are focused onto multiple absorbers. In addition, the reflectors in CLFR power stations are arranged into vertically staggered rows. This reduces adjacent rows of reflector casting shadows on each other as the sun progresses through the sky throughout the day.

The orientation of the reflectors is adjusted to maximise the sunlight reflected onto the absorber. This helps to account for daily and seasonal variations in the sun's path through the sky.

Reflector supports are currently made from a support deck having a curved bearing surface to which the reflectors are secured. The curved bearing surface assists in ensuring that the reflectors focus the sunlight onto the absorber. That curved surface also helps to ensure the deck provides adequate support to the reflector along its length and across its width.

The reflectors used in LFR and CLFR power stations utilise the Fresnel lens effect. These mirrors have a large aperture and a short focal length, which allows the mirror to efficiently and accurately concentrate sunlight into the absorber.

The arrangement of reflectors creates a number of problems for manufacture of CLFR power stations. It is necessary for the rows to be long enough to minimise non-reflective components and maximise use of land area. Furthermore, the rows must be supported only at each end with no support for the rows at points along their length. This is because the reflector support must be able to rotate through 360 degrees about an axis extending along its length. This rotation facilitates cleaning, maintenance and replacement of reflectors.

Furthermore the supports must be rigid enough to withstand the static loads experienced in use. Those static loads are the combined result of the materials forming the support, the weight of reflectors, and the lengths which the supports must span without support. Deflection of the supports from an equilibrium (non-loaded position) can result in cracking of the reflectors.

The traditional approach to designing and manufacturing reflector supports for CLFR power stations has been to increase the amount of materials used e.g. use thicker sheets of material. However, this increases the static loads on the reflector supports. As a result reflector support design often falls into a vicious cycle of increasing the weight of components to obtain additional strength, which in turn increases static loads and requires additional support.

The logistics of manufacturing, transporting, and installing reflector supports can also be problematic.

It has also been proposed that the reflector supports could be constructed in shorter length modules, transported to site, and connected together to form a reflector support having the desired length. However, the existing designs of reflector supports do not facilitate that type of construction partially because the components forming the structure have round cross-sections. That means that the components do not have a surface area conducive to the use of mechanical fasteners to secure two adjacent modules together.

Furthermore, it is necessary that the reflector supports are made from galvanised steel to ensure that they can withstand the environmental conditions that they may experience in use, and last for a reasonable time period. This is particularly relevant as CLFR power stations are generally constructed in inhospitable locations.

It is not however possible to weld galvanised materials. As a result, the existing reflector supports are generally constructed using welding techniques to the total length required, and then galvanised before transport.

Therefore, the fully assembled and galvanized reflector supports are subsequently transported to the site at which the CLFR power station is being constructed. However, transport can be a problem because the reflector supports are in excess of 20 metres in length. These components therefore often exceed the standard dimension for shipping which complicates transportation, and significantly increases costs.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### DISCLOSURE OF THE INVENTION

According to another aspect of the present invention there is provided a reflector support deck, including

at least one corrugated sheet of material having two or more ridges of differing heights,

characterised in that

the ridges are positioned relative to each other so that the crests the ridges collectively define a curved bearing surface that curves about a single axis.

According to another aspect of the present invention there is provided a method of manufacturing a reflector support deck,

wherein the reflector support deck includes a corrugated sheet of material having two or more ridges of differing heights,

the method including the steps of:
(a) feeding a length of a sheet material into a forming device;
(b) engaging the forming device to deform the length of sheet material to create ridges, such that the ridges are positioned relative to each other so that the crests of the ridges collectively define a curved bearing surface that curves about a single axis.

According to one aspect of the present invention there is provided a reflector support module, including

a reflector support deck,

a first support arm formed from a sheet of material,

a second support arm formed from a sheet of material,

wherein the support arms are secured to each other and to the reflector support deck to form a substantially rigid structure,

and wherein the support arms include complementary surfaces that bear against each other

According to another aspect of the present invention there is provided a method of manufacturing a reflector support,

wherein the reflector support includes a reflector support deck, a first support arm formed from a sheet of material, and a second support arm formed from a second sheet of material, the method including the following steps in any order:
(a) positioning the first and second support arms with respect to each other;
(b) securing a reflector support deck to the first and second support arms;
(c) securing the first and second support arms to each other so that complementary surfaces of the first and second support arms bear against each other.

According to another aspect of the present invention there is provided a reflector support including one or more reflector support modules.

Throughout the present specification, reference to the term “reflector support module” should be understood as meaning a component as described above that contributes to the overall length of the reflector support.

The present specification describes in particular reflector supports for use in Linear Fresnel Reflector and/or compact Linear Fresnel Reflector power stations (referred to herein collectively as “LFRs”).

Curved bearing surfaces for mirrors are known in the prior art. See for example United States Patent Publication No. 2006/0012895 which discusses light weight mirror blank supports. These supports are particularly intended for use with high end telescopes such as those used in ground or space based astronomy.

However, the mirror supports of United States Patent Publication No. 2006/0012895 all have bearing surfaces which have a spherical curve e.g. curve in two or more axis. This is because telescopes require mirrors to reflect and concentrate an image/light to substantially a point.

In contrast LFRs require reflectors to reflect an image/light to a long narrow focus point. maximising the length of the focus point will assist in maximising the efficiency of the LFR.

It would be impossible to take the mirror supports of United States Patent Publication No. 2006/0012895 and adapt them for use in LFRs due to the shape of the bearing surfaces. Simply put, using United States Patent Publication No. 2006/0012895 in an LFR application would require a series of individual reflector supports along the length of the LFR, and use of individual spherical mirrors. That would be an inefficient arrangement.

In addition, the forming techniques discussed in United States Patent Publication No. 2006/0012895 are costly. That is acceptable for the high value mirrors and telescopes subject of the invention described in United States Patent Publication No. 2006/0012895. However, the cost of those techniques would prohibit use of the invention described in United States Patent Publication No. 2006/0012895 in applications such as LFRs which require considerable lengths of reflector supports.

Throughout the present specification, reference to the term “reflector support” should be understood as meaning an assembly to which a reflector may be secured, and that in-use holds a reflector(s) in position.

In particularly preferred embodiments, the reflector supports are configured to be mounted on axles. The axles are preferably aligned with the longitudinal axis of the reflector support and rotated to rotate the reflector supports.

It should be noted that the reflector supports are supported only at two points, being at or near the ends of the reflector support's length. That is, the reflector support is supported only at the points where the axles are secured to the reflector supports. This is as should be understood by one skilled in the art.

Throughout the present specification, reference to the term “reflector support deck” should be understood as meaning the part of a reflector support to which a reflector(s) is secured.

Further aspects of the reflector support deck should become clearer from the following description.

Throughout the present specification, reference to the term “reflector” should be understood as meaning a device to reflect and concentrate light.

In a particularly preferred embodiment, the reflector(s) with which the present invention is intended for use are mirrors having a large aperture and narrow focal point. These mirrors are as should be understood by one skilled in the art and is commonly used in LFRs.

The reflectors have a reflective surface and a back surface. The back surface has a curve corresponding to the curve of the reflective surface. This is because the reflectors are made from glass having a reflective substance coated thereon, and it is not currently possible to manufacture tapered glass. Accordingly, the cross sectional area of the reflectors along their length is constant.

In addition, these types of reflectors are fragile. This is because the types of glass from which they are made is brittle, and they are often thin, having thicknesses in the range of 3-5 mm.

The result of the forgoing is that a curved bearing surface must be provided to sufficiently support the reflector.

Throughout the present specification, reference to the term “support arm” should be understood as meaning a structural component to support the reflector support deck.

In a preferred embodiment the reflector support modules according to the present invention may include support arms that extend along the entire length of the reflector support so the support arms can therefore support the reflector support deck at positions along its length.

In a particularly preferred embodiment, the arrangement of the support arms and support deck in the reflector support modules forms a triangular shape when a reflector support module is viewed end on.

The inventors have identified that the reflector support having a triangular shape may be particularly beneficial in LFRs. This is because the shape ensures that the reflector support has sufficient integral strength to be able to withstand the static loads experienced as it is rotated about its longitudinal axis.

In contrast, the inventors have found that other shapes of the reflector support do not have sufficient strength to withstand those static loads without significantly increasing the weight of material used.

For instance a reflector support module having a square shape could collapse. In these embodiments increasing the thickness of sheet materials used in manufacturing the reflector support modules would not provide the required strength. Rather, the additional weight of material would increase the static load experienced by the reflector support module in use and increase the chances of failure. As a result, the triangular shape of the reflector support module may be particularly beneficial.

In particularly preferred embodiments, the sheet of material may be sheets of galvanised steel. In these embodiments, the sheets may be provided in coils. The coils can be continually fed into a forming device, or cut to length before being fed into a forming device.

In a particularly preferred embodiment, the sheets have a width of 1800 mm. This width is the widest of galvanised steel sheets currently being manufactured.

The inventors have found that sheet steel having this preferred width is particularly advantageous in manufacturing a reflector support. This width enables support arms capable of supporting the reflector deck to be formed from a single sheet of material.

In addition it is not necessary to join two or more sheets of material together. Such joins would require overlapping of sheets and increase the weight of the reflector support.

Further joining two sheets of material would increase the number of joints which are potential weak spots, and therefore reduce the strength of the reflector support module.

However, the forgoing should not be seen as limiting on the scope of the present invention as alternatives for the sheet(s) of material are envisaged.

In a preferred embodiment the sheet of material may have a thickness in the range of 0.5-2 mm.

In a particularly preferred embodiment, the components forming the reflector support module may each be made from a sheet of material having a different thickness to the other sheet(s). For instance, in one embodiment, the reflector support may be made from a sheet of material having a thickness of substantially 0.6 mm, while support arm(s) may be made from a sheet having a thickness of substantially 1.6 mm.

The inventors have identified that these ranges for sheet thickness and the preferred embodiments are particularly beneficial. For instance, the sheets are thin enough that they do to not increase the weight of the constructed reflector support module. In addition, these ranges of thicknesses provide the sheets of material with sufficient strength for the components once formed.

Furthermore, the thickness of the sheets enables them to be manipulated to form the components of the reflector support module without tearing or ripping. The selection of the sheet thickness is particularly important to forming the components of the present invention due to the unique arrangement of these. Therefore, sheet thickness is an important consideration and manufacturing reflector support modules according to the present.

In a preferred embodiment, the sheets of material may be stainless steel having a grade of 200-600 MPA.

In a preferred embodiment, the grade of the sheet material forming a component is selected according to the specific components. For instance, preferably the support arm(s) are formed from stainless steel having a grade of 300 MPA, while the corrugated sheets of the reflector support deck are stainless steel of a grade of 450 MPA.

However, the forgoing should not be seen as limiting on the scope of the present invention. It is also envisaged that the stainless steel sheets can be formed from other grades of stainless steel, or non-stainless steel material.

In a preferred embodiment, the sheet of material may be pretreated with a coating material.

Throughout the present specification, reference to the term “pretreated with a coating material” should be understood as meaning a protective layer(s) applied to an outer surface(s) of the sheet material.

In preferred embodiments, the sheets of material may be galvanised, zinc coated, or coated with paint.

The protective coating protects the sheet material, and the components of the reflector support module(s) formed using the material. Therefore, the manufactured reflector support modules may be better able to withstand environmental conditions. In addition, the protective coating may reduce or otherwise prevent corrosion of the components of the reflector support module. The result of the foregoing is that the reflector support modules may be more durable. Throughout the present specification reference to the term “complementary surfaces” should be understood as meaning at least two surfaces having corresponding shapes.

In a preferred embodiment the corresponding shapes may be flat surfaces that bear against each other when the support arms are adjacent to each other.

However, the foregoing should not be seen as limiting as alternatives are envisaged as being within the scope of the present invention. For example the complementary surfaces may be curved surfaces or triangular surfaces.

In a preferred embodiment the complementary surfaces are mated with each other so as to engage with each other and provide resistance to the surfaces moving.

In a particularly preferred embodiment the engagement of the complementary surfaces may be created by deforming the surfaces.

However, the foregoing should not be seen as limiting on the scope of the present invention as alternatives are envisaged, including those where the complementary surfaces are not mated.

Throughout the present specification reference to the term “bear against” should be understood as meaning that the complementary surfaces are engaged with each other. Therefore the surfaces provide a frictional resistance to movement of the support arms relative to each other.

The inventors have identified that having complementary surfaces which bear against each other may help to increase the rigidity of the reflector supports. In addition, the complementary surfaces facilitate securing the support arms together.

In contrast, the prior art reflector supports do not have complementary surfaces. Therefore the flat end surfaces of the arms bear against the curved surfaces of other arms. Those arrangements do not provide an adequate contact to secure the components together using non-welding techniques.

In a particularly preferred embodiment, the support arm(s) may include one or more apertures.

In a particularly preferred embodiment, the apertures in the support arm(s) have a triangular shape.

The inventors have identified that forming apertures in the support arms may improve the ability of the reflector support modules to withstand the necessary static loads experienced in use.

This is surprising because traditional engineering wisdom is that to increase the strength of a component more material should be used e.g. use thicker sheets of steel to increase strength. This arrangement is not possible in manufacturing reflector supports because these must be unsupported except at each end. That arrangement leads to the weight of the reflector being a primary design issue.

In a preferred embodiment, each support arm(s) may be formed from a single sheet of material. In these embodiments, the single sheet of material is deformed by a forming device to the necessary shape.

The inventors have identified that it is possible to manipulate a sheet of material so as to provide a support arm having the necessary rigidity.

In a particularly preferred embodiment, the length of a support arm(s) may extend substantially parallel to the length of the reflector support deck.

In these embodiments, each support arm(s) may be a single component which can support the reflector support deck along its length. Therefore, it is not necessary weld or otherwise connect a large number of individual arms together to support a reflector support deck. This is a significant saving in labour and therefore facilitates decreasing manufacturing costs.

Furthermore, it is possible to accurately create the desired shapes for the components of the reflector support. Accordingly, the reflector supports of the present invention may provide an improved solution to the problems with manufacturing reflector supports in LFRs. However, the foregoing should not be seen as limiting on the scope of the present invention. It is also envisaged that the support arm(s) may be formed from two or more sheets of material.

In a particularly preferred embodiment the support arms may be secured together by crimping the complementary surfaces of the support arms. In this embodiment, pressure is applied to the complementary surfaces to deform these into mated components. The resulting shape and configuration of the components provides resistance to the support arms moving with respect to each other, thereby securing the components together.

However, alternatives are also envisaged including those using mechanical fasteners such as nuts and bolts, screw type fasteners, and clamps. In these embodiments the mechanical fasteners extend through the complementary surfaces to secure the support arms together. Therefore, the forgoing should not be seen as limiting.

The inventors have identified that the preferred methods of securing the support arms can significantly reduce the costs of manufacturing reflector supports. This is because the skill and time required to accurately weld components together to manufacture a reflector support for LFRs is significant. Crimping on the other hand is less labour intensive than welding.

Furthermore, the present inventions remove the need for labor intensive and difficult quality control steps like checking the orientation of the components before and after welding

In addition, the inventors have found that crimping provides sufficient strength for the reflector support to perform its intended use. This may be due to the interaction of the components forming the reflector supports of the present invention, and that in preferred embodiments each support arm is formed from a sheet of material.

It should be appreciated that the use of crimping is not simply a design choice. There is a binding interaction between the deformed surfaces e.g. the support arms, and/or the reflector support deck. That interaction helps to increase the rigidity of the reflector support.

Throughout the present specification, reference to the term “substantially rigid structure” should be understood as meaning that the reflector support does not deflect more than a specified standard.

In operation, the reflector support preferably does not deflect more than 10-20 mm from its equilibrium support e.g. the position when the substantially rigid structure is lying flat on a substantially horizontal plane with no load thereon.

Ideally, the reflector support does not deflect more than substantially 15 mm from its equilibrium position.

However, the foregoing should not be seen as limiting on the scope of the present invention.

In preferred embodiments, the reflector support may be constructed from one or more reflector support modules.

In preferred embodiments, there is a reflector support which includes one or more reflector support module(s) having a length of:
11-12.5 metres, and more preferably in the order of 12 metres; and
4-6 metres, and more preferably in the order of 5 metres.

Constructing the reflector support from a plurality of modules provides a number of advantages. For instance, each module can have a length within the standard shipping dimensions. Therefore, the costs of transporting components to a construction site may be reduced.

In contrast, the reflector supports of the prior art are generally preassembled to the length needed for the purpose, and then shipped to site. Given that these reflector supports often have a length of 22 metres the transport costs are significant. Accordingly being able to manufacture reflector supports from shorter length modules is a significant potential cost saving.

In addition, the preferred construction of the reflector support modules means they can be nested together to maximise the use of space within shipping containers. Again, this may significantly reduce transportation costs. In contrast, the known reflector supports have insufficient strength and rigidity to be nested together. Rather, they would collapse which would prohibit them being nested for transportation purposes.

In a particularly preferred embodiment, reflector supports according to the present invention may be constructed from three or more reflector support modules.

The inventors have identified that using at least three support modules may help to ensure that there are no joins between modules near the centre of the reflector support. This is particularly beneficial as joints at the centre experience considerable forces when used and are therefore prone to failure. As a result, ensuring that there are no joints near the centre addresses a significant problem with manufacturing reflector supports from modules.

In particularly preferred embodiments the reflector support modules may include end on connectors.

Throughout the present specification reference to the term “end on connectors” should be understood as meaning components to secure two reflector support modules together in an end on manner.

In a preferred embodiment the end on connectors may be complementary flanges on the end of each module. To assemble the reflector support the modules are abutted together in an end on manner. In doing so, the flanges align. Mechanical fasteners such as bolts and nuts can be used to secure the flanges, and thereby the reflector support modules, together.

These aspects of the present invention should become clearer from the following description.

Throughout the present specification, reference to the term “forming device” should be understood as meaning one or more devices that can manipulate the shape of a sheet of material.

The forming device may be a roll former, a press and/or cutting station. These embodiments for the forming devices are as should be understood by one skilled in the art.

In particularly preferred embodiments, the forming device may be a production line including one or more roll formers, one or more presses, one or more cutting stations, and/or one or more decoilers.

In these embodiments, the devices forming the production line individually or collectively manipulate galvanised sheet steel to shape the components forming a reflector support module and/or reflector support deck.

However, the foregoing should not be seen as limiting on the scope of the present invention as it is also envisaged that the forming device(s) may take other embodiments.

Throughout the present specification, reference to the term “corrugated sheet” should be understood as meaning a sheet of material having corrugations. The corrugations are defined by ridges and troughs in the sheet of material.

This is as should be understood by one skilled in the art.

Throughout the present specification reference to the term “ridge” should be understood as meaning a long raised section of the sheet of material.

Throughout the present specification, reference to the term “crest” should be understood as meaning the top surface of a ridge. In use, the crest is the surface of a ridge to which a reflector is secured. Therefore the crests provide a bearing surface.

Throughout the present specification reference to the term “trough” should be understood as meaning the lowest point of a corrugation between two ridges.

Throughout the present specification reference to the term “base plane” should be understood as meaning an imaginary surface from which the ridges extend.

In a preferred embodiment, the ridges extend substantially along the entire length of the sheet of material.

However, it is also envisaged that a ridge(s) may be discontinuous along the length of the corrugated sheet. Accordingly the foregoing should not be seen as limiting.

In a preferred embodiment, the ridges may have a substantially trapezoidal cross section.

However, the forgoing should not be seen as limiting as the ridges can have other cross sections such as triangular or curves.

In a preferred embodiment, one or more of the crests are curved.

In these embodiments, the curved crests collectively define a curved bearing surface.

Throughout the present specification, reference to the term “curved bearing surface” should be understood as meaning a surface to which a reflector(s) can be secured and which has a curve.

In addition, the space between the adjacent ridges enables airflow along the reflector support decks. That airflow can be beneficial to cooling of the reflectors.

The curved bearing surface is a section of a cylinder. This should be understood as referring to an outer surface of an imaginary cylinder having a radius and a length.

The length of the curved bearing surface is substantially the length of the reflector support module(s) according to the present invention.

The radius of the curved bearing surface can be selected according to the curve of the reflector(s) to be used with the reflector support modules. Therefore, the curved bearing surface may have a radius in the range of 20-50 metres, and more preferably in the order of 30 metres.

It should be understood that the radius of the curved bearing surface can be selected to correspond to the curve of the reflector to be secured to the reflector support module. That radius is therefore selected according to the parameters known to one skilled in the art. However, a key feature of the present invention is that the curved bearing surface is defined by creating curved ridges and the orientation of two or more ridges relative to each other.

However, the foregoing should not be seen as limiting on the scope of the present invention. Alternatives are also envisaged.

Throughout the present specification reference to the term “single axis” should be understood as meaning that the curved bearing surface about only one axis.

In a preferred embodiment, the single axis extends along the length of the reflector support module.

In contrast, reflector supports with curved bearing surfaces according to the present invention to the inventors' knowledge all curve about two or more axis. For instance, US Patent Publication No. 2006/0012895 discloses mirror support blanks with spherical bearing surfaces e.g. the bearing surfaces curves about two axes.

The use of a bearing surface that curves about a single axis is particularly beneficial for reflector supports used with LRFS. For instance, having a bearing surface that curves about a single axis enables the bearing surface to support a reflector along a greater length than the mirror support blanks of US Patent Publication No. 2006/0012895.

That is useful where a reflector/mirror is required that can focus light to a long focus point.

In a preferred embodiment, the reflector support deck may be made from two or more sheets of material secured together.

In a particularly preferred embodiment, the two or more sheets of material forming the reflector support deck are both corrugated.

The two or more sheets of material are preferably orientated so that their ridges are substantially perpendicular to each other. This may increase the strength and rigidity of the reflector support deck. Therefore, for a relative weight of sheet material a desired strength for the reflector support deck can be achieved. The inventors have surprisingly found that the interaction of the two or more sheets of material, and the orientation of the ridges, may significantly and unexpectedly increase the strength of the reflector support deck.

However, the foregoing should not be seen as limiting as alternatives are envisaged. Those include reflector support decks made from single sheets of material, or three or more sheets of material, or two sheets of material having substantially parallel corrugations.

In a preferred embodiment, the two or more sheets of material forming the reflector support deck may be secured together at substantially all points of contact between the two sheets.

In the particularly preferred embodiments where the reflector support deck is formed from two sheets of material having ridges, the points of contact are those where troughs of ridges on one sheet contact crests of ridges on another sheet.

The inventors have identified that securing the two sheets of material at substantially all points of contact effectively forms a single sheet of material. This may be particularly beneficial in providing a comparatively stronger reflector support deck for a lower weight of material.

In particularly preferred embodiments, securing of the two sheets of material forming the reflector support deck occurs by crimping the sheets where one sheet bears on another.

However, this should not be seen as limiting as other forms of securing the two sheets of material together are envisaged as being within the scope of the present invention.

It should be appreciated that the present inventions provide a number of advantages over reflector support decks according to the prior art. These may include:
Involving considerably less skill and labour to manufacture than the prior art supports and methods, thereby significantly reducing the costs of manufacture.
Reducing the volume of material necessary to manufacture a reflector support, thereby reducing the costs of manufacture.
Being capable of being manufactured and transported to site in short length modules. Thereby decreasing transportation costs and the overall costs of manufacturing LFRs.
Providing a cost effective method to manufacture a reflector support deck having a curve to the necessary degree of accuracy.

### BRIEF DESCRIPTION OF THE DRAWINGS

Further aspects of the present invention will become apparent from the ensuing description which is given by way of example only and with reference to the accompanying drawings in which:

FIG. 1 is a side view of an assembled reflector support according to the present invention;

FIG. 2 is a view through Section A-A of FIG. 1;

FIG. 3 is an end on exploded parts view of a reflector support module;

FIG. 4 is an end on view of a curved bearing surface provided by a first corrugated sheet;

FIG. 5 is an isometric exploded view of a section of a reflector support according to the present invention;

FIG. 6 is a close up view of a Section of FIG. 1;

FIG. 7 is an isometric view of an aperture in a truss arm;

FIG. 8 is an isometric view of a reflector support according to the present invention;

FIG. 9 is an end perspective view of an end cap secured to a reflector support module;

FIG. 10 is a view through section B-B in FIG. 1, showing securing of reflector support modules secured together lengthwise;

FIG. 11 is a schematic showing a method of manufacturing a reflector support according to the present invention;

FIG. 12 is a plan view of an assembled reflector support with reflectors secured thereto;

FIG. 13 is a view through line A-A in FIG. 12; and

FIG. 14 is a view through section B-B in FIG. 12.

### BEST MODES FOR CARRYING OUT THE INVENTION

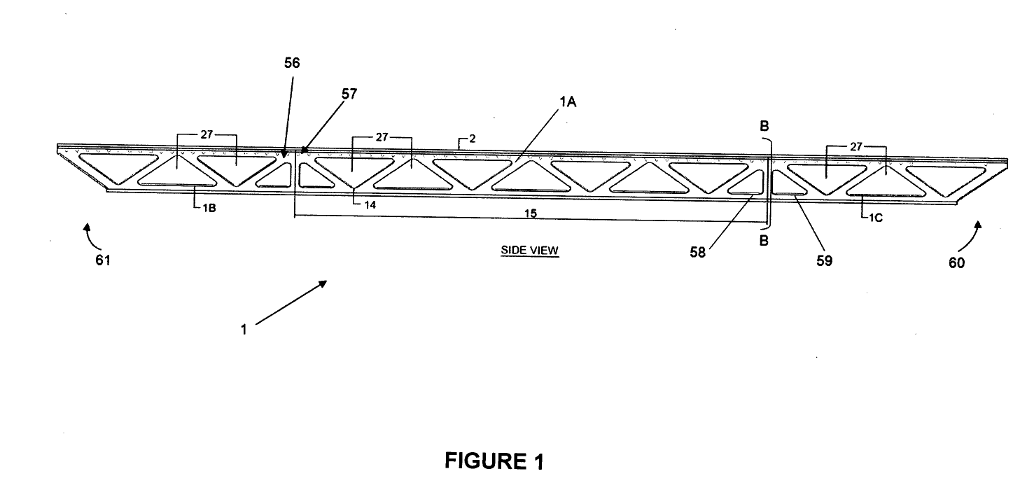

FIG. 1 shows a side view of a reflector support indicated generally as (1). The reflector support (1) is constructed from a plurality of reflector support modules (1A, 1B, and 1C).

The reflector support modules (1A-1C) are and differing mainly in their respective lengths. Therefore, only reflector support module (1A) will be discussed herein.

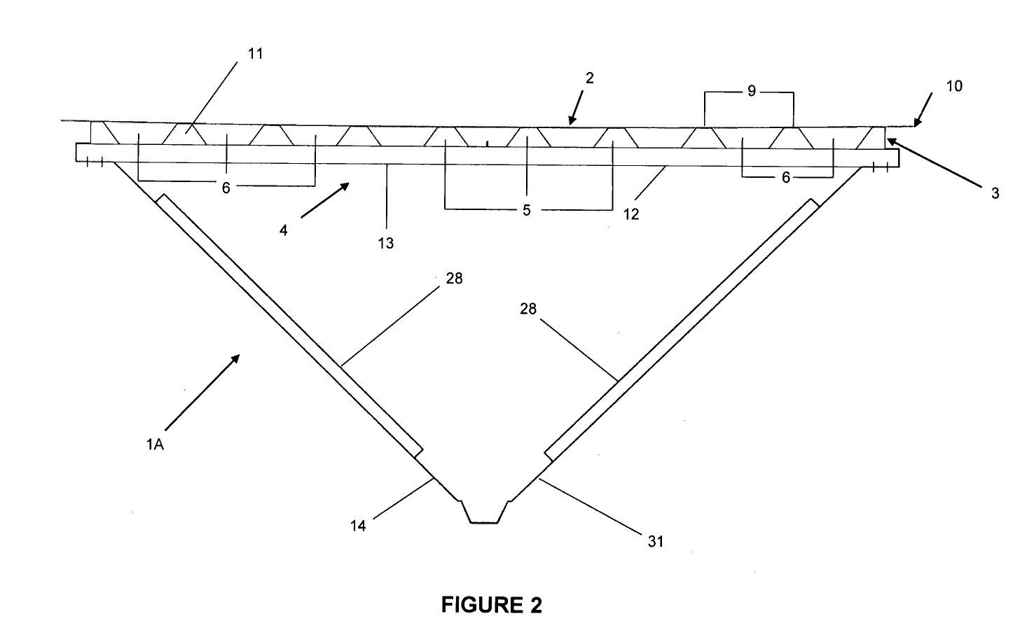

Referring now to FIG. 2.

The reflector support module (1A) includes a reflector support deck indicated generally as (2).

The reflector support deck (2) is formed from a first corrugated sheet (3) and a second corrugated sheet (4).

The first corrugated sheet (3) has a plurality of ridges (5) that are separated by troughs (6). The corrugations extend along the length of the first corrugated sheet (3).

The troughs (6) are flat surfaces and all substantially lie on a flat plane (7). The ridges (5) extend away from the plane (7) and have a substantially trapezoidal cross section.

Each ridge (5) has a crest (9), being the top surface of the ridge (5)

The crests (9) are not parallel to the plane (7). Rather the crests (9) are all curved and lie on an imaginary curved plane indicated by (10).

Each crest (9) has a height (8). However, the heights (8) are not uniform across each ridge because the crests are curved.

In addition, each ridge (5) has a different height to each other.

The cross section of each ridge is constant along its length.

The ridges are positioned relative to each other so that collectively the crests (9) define a curved bearing surface which lies on imaginary plane (10).

The curved bearing surface curves about a single axis that extends along the curved bearing surface (not shown). The axis extends along the length of reflector support modules 1A, 1B, 1C.

The curved bearing surface has a radius of 180 metres the radius is the distance between axis and the curved bearing surface.

The curved bearing surface in effect lies on an outer surface of an imaginary plane which can be considered to be a section of a cylinder. The cylinder has a radius of 180 metres and a length substantially equal to the length of the reflector support module.

The axis lies at the centre of the cylinder.

The second corrugated sheet (4) has a plurality of ridges (11) separated by troughs (12).

Each ridge (11) has a crest (13). The crests (13) all lie on the same flat plane (not indicated in the Figures).

Troughs (12) all lie on a flat plane (not indicated in the Figures).

The troughs (12) and ridges (11) are substantially flat, so that the respective planes on which they lie are substantially parallel.

A first support arm (14) is formed from a sheet of galvanised stainless steel.

The first support arm (14) has a length indicated by line (15) and a width dimension (16). The width dimension (16) is the distance between inner edge (17) and outer edge (18).

The first support arm (14) has a first complementary surface (19) that extends along the length (15). The first complementary surface (19) extends from the inner edge (17) to edge (20). A step (21) extends away from first edge (20) to an upper edge (23).

A main body section (22) extends away from upper edge (23) of step (21) and to outer edge (25) of main body section. In addition the main body extends substantially along the entire length (15).

A second complementary surface (24) extends away from outer edge (25) of main body (22).

A flange (26) extends upwards from second complementary surface (24) and is folded back over top of second complementary surface (24).

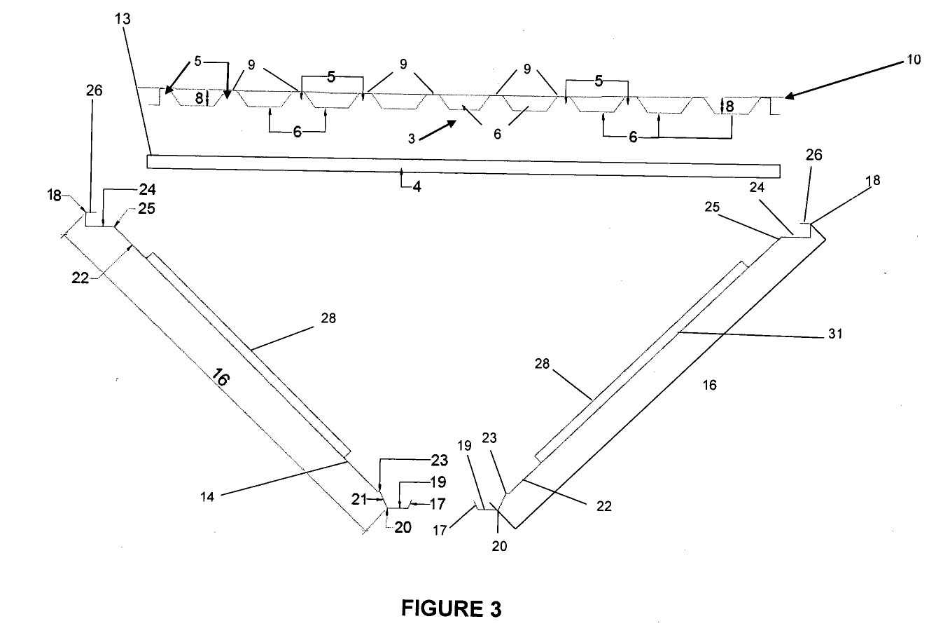

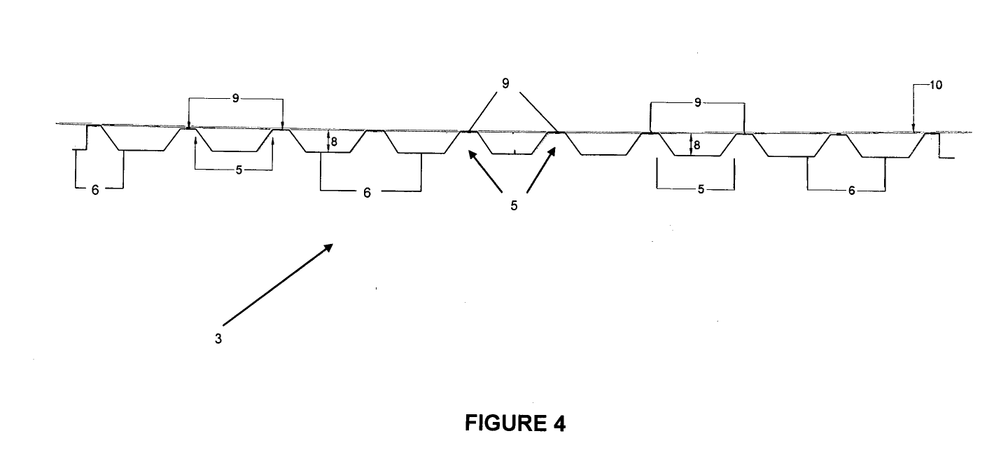

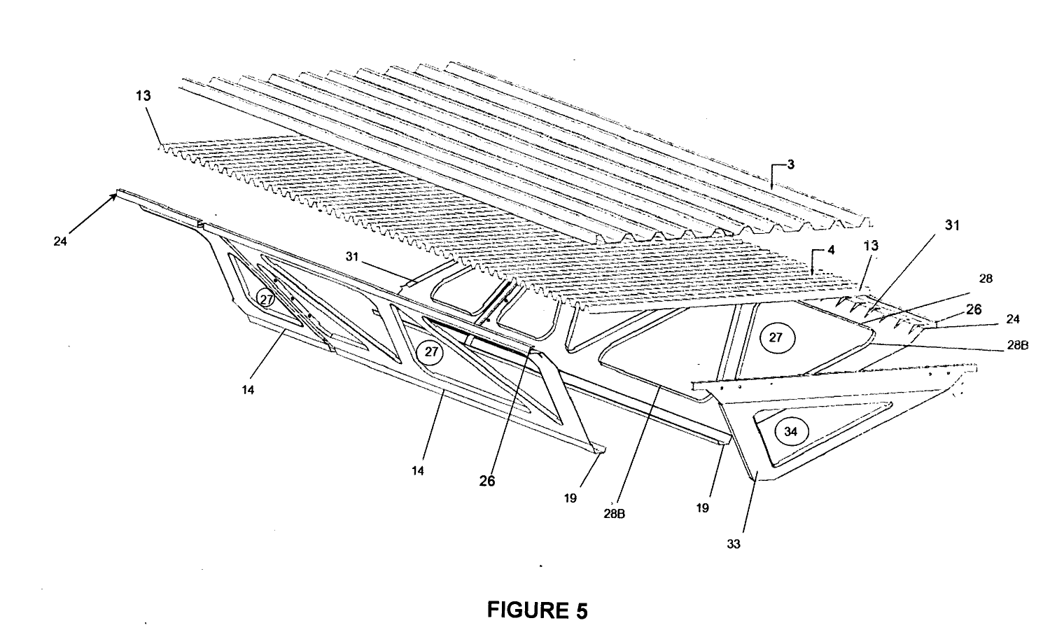

The above features are also shown in FIG. 3 being an exploded view of FIG. 2, and FIG. 4 being an end on view of a first sheet of corrugated material (3). This forms part of the reflector support deck (2), and FIG. 5 is an exploded isometric view of a reflector support (1).

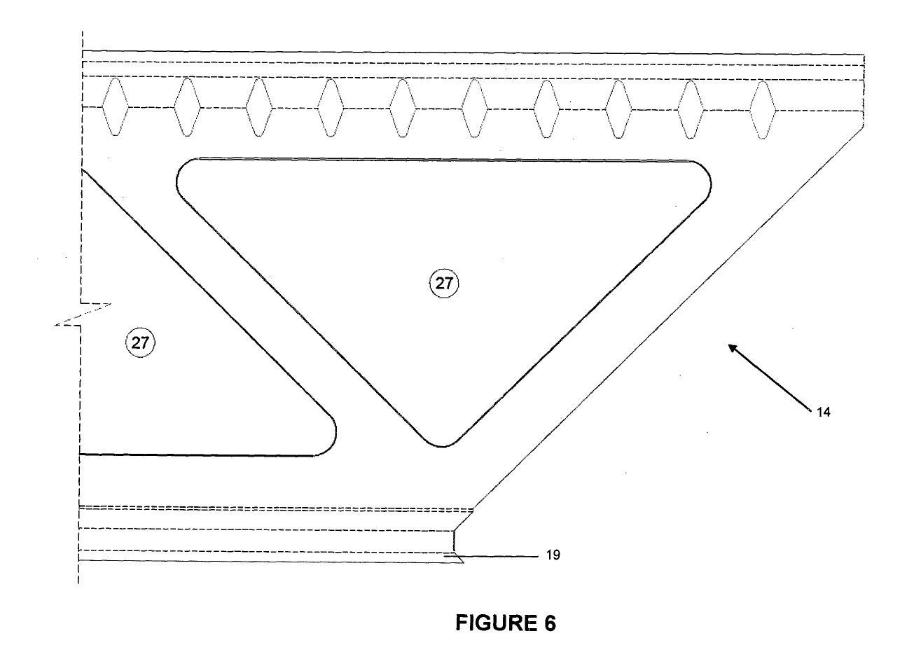

Referring now to FIG. 6 which shows a close up view of a section of FIG. 1.

The collars (28) are substantially perpendicular to inner face (29) of first truss arm (14).

A series of apertures (27) are formed in main body section (22).

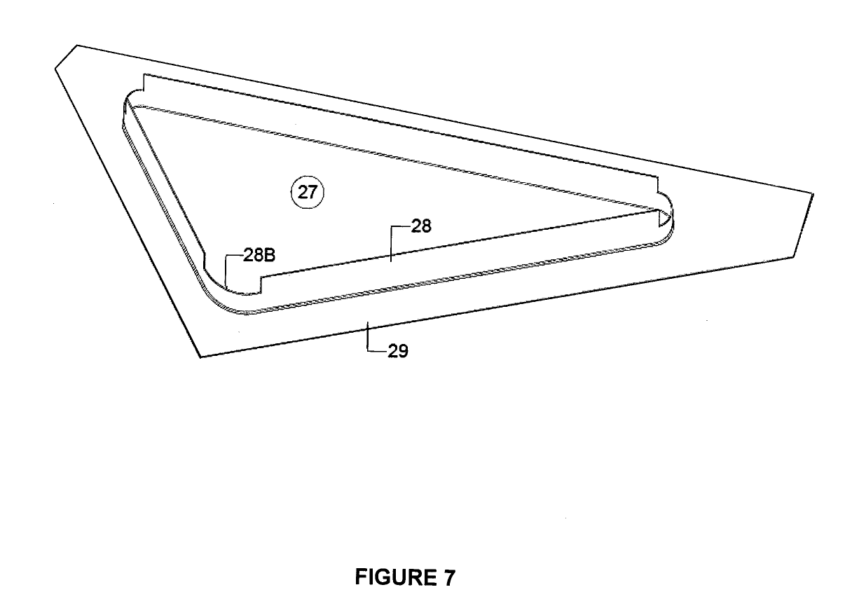

Referring now to FIG. 7 which shows a close up isometric view of an aperture and collar (28).

The apertures (27) have collars (28) which extend substantially around the entire perimeter of the aperture (27). However, the collars (28) have a cut out section (28B) at each corner of the aperture (27). The cut out sections (28B) are parts of the collars (28) that are lower than the rest of the collar (28).

The collars (28) are formed by folding the sheet material forming the first arm (14) as will be discussed in more detail below.

Outer face of support arm (14) is substantially flat along the length (15).

Figure eight shows a cross sectional view through reinforcing arm (32). Ridges (33) are formed into the reinforcing arm (32). The ridges (33) provide additional strength to the arm (32) and may increase the strength of the first truss arm (14).

The reflector support (1) includes a second support arm (31) that is identical to first support arm (14). Therefore second support arm will therefore not be discussed in detail. However, like numerals refer to like components.

The first and second arms (14, 31) are secured together by crimping the first complementary surfaces (19).

The reflector support deck (2) bears on second complementary surfaces (24). The second corrugated sheet (4) is secured to the first and second support arms (14, 31) by crimping as will be discussed in more detail below. All troughs (12) and crests are crimped together.

Reflectors (not shown in FIGS. 1-4) can be secured to the curved bearing surface (10) as will be discussed in more detail below.

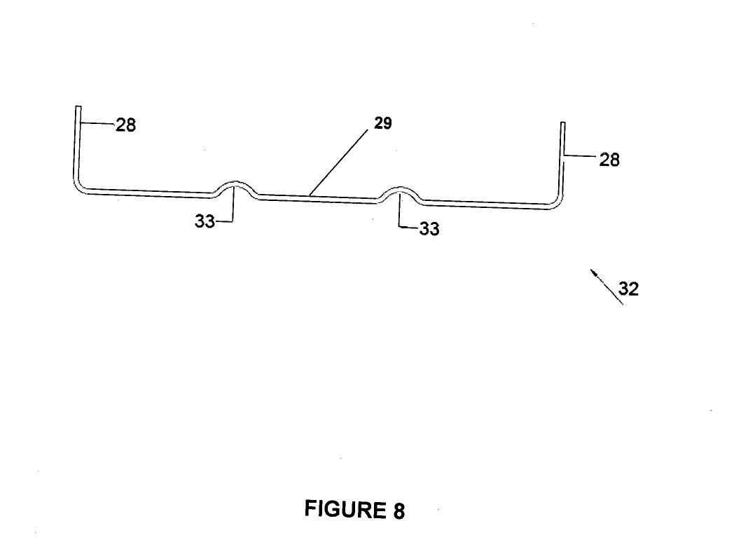

The first and second support arms (14, 31) and reflector support deck (2) from a monocoque structure. The structure has sufficient rigidity such that it can support its own weight under transport. In addition, the monocoque structure ensures that the reflector support (1) can support the weight of reflector (not shown in FIGS. 1-11) when assembled.

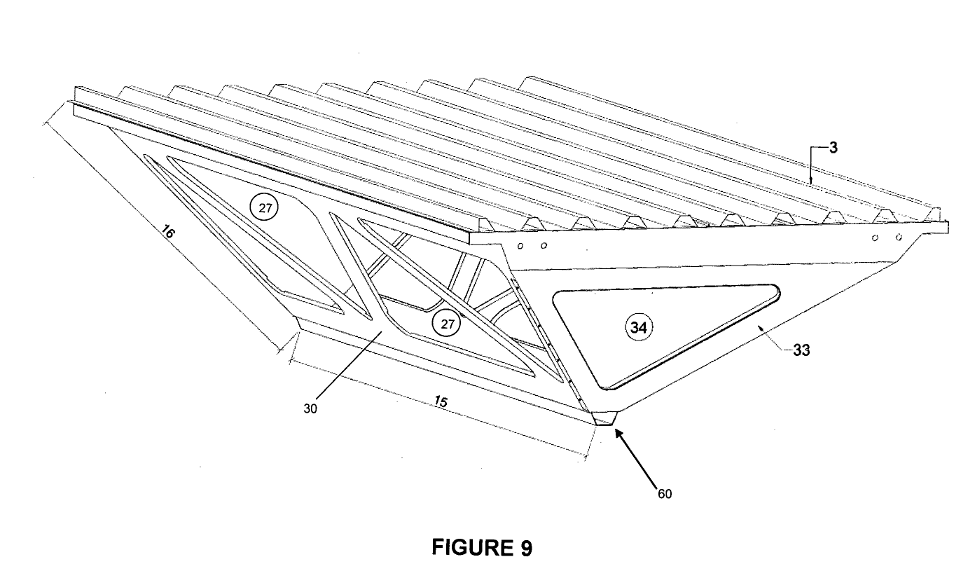

FIG. 9 shows an end cap (33) that can be used to reinforce a module (1A-1C). The end caps (33) have a triangular shape generally corresponding to the cross-section the reflector support modules (1A-1C).

An aperture (34) is provided in end cap (33). This decreases the weight of the end cap (33).

The end cap can be secured to an end face of a reflector support module (1A-1C) using mechanical fasteners such as screws or nuts and bolts.

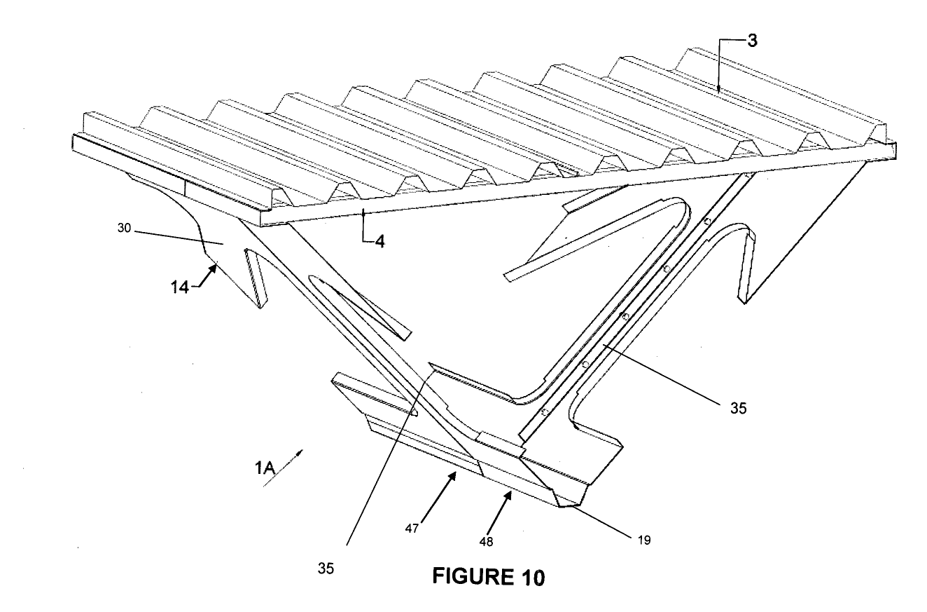

FIG. 10 shows a view through line B-B in Figure one and the end on attachment of two modules (1A, 1B, and/or 1C).

Edges of first and second support arms (14, 31) are folded towards inner faces to form length wise connection flanges (35). The flanges (35) are substantially perpendicular to the length of support arms (14, 31).

The flanges (35) are orientated so that when two reflector support modules (1A-1C) are aligned in an end on manner the flanges (35) lie substantially adjacent to each other. Therefore, bolts (not shown) can be inserted through the flanges (35) to secure the reflector support modules (1A-1C) together.

The orientation of the first and second support arms (14, 31) helps to distribute the load through the flanges (35) and into the first and second support arms (14, 31). Accordingly, the orientation of the flanges assists in securing reflector support modules (1A-1C) together in an end on manner and ensuring that the reflector support does not deflect from an equilibrium position more than a necessary standard.

### Method of Manufacture

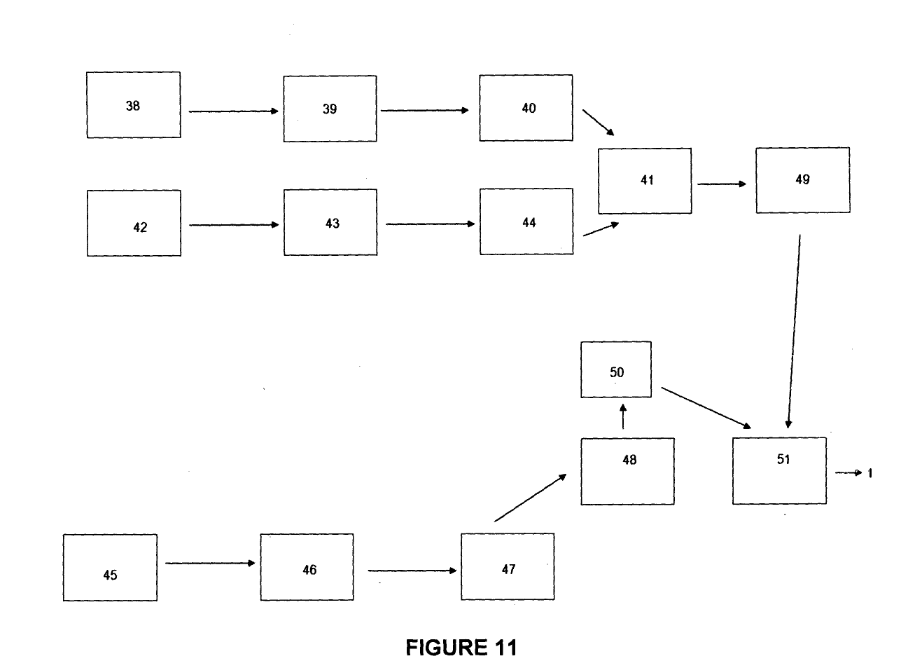

Referring now to FIG. 11.

A decoiler, generally indicated as (38) holds coils of 1.8 meter wide, 450 MPA, 0.6 mm thick galvanised steel (not shown).

The decoiler (38) continuously feeds the steel sheets into roller former (39).

The cut lengths are transferred to stacking station (41). The cut sheets are stored in stacking station (41) until required for manufacturing a reflector support module (1).

The roll former (39) includes dies (not visible in the drawings). A sheet steel passes through the roll former (39) the dies (not shown) apply pressure to deform the sheets and create corrugations in the form of ridges (6).

The dies are uniquely orientated and configured to create ridges having a substantially trapezoidal shape but with a curved crest. The trough (6) between each ridge (5) is flat, and all substantially lie on the same flat plane (7).

The deformed sheets exit roll former (39) and enter cutting station (40). Cutting station (40) cuts the deformed sheets into lengths (3).

The cut sheets (3) are transferred to stacking station (41) where they are stored until required.

A second decoiler (42) holds coils of 1500 mm wide, 0.6 mm thick, 450 MPA galvanised steel sheets (not shown).

The stainless steel sheets (not shown) are continuously fed into second roll former (43). The roll former (43) includes dies (not visible in the drawings). As the sheet steel passes through the roll former (43) the dies exert pressure to deform the sheets and create corrugations in the form of ridges (11).

As the sheet material exits second roll former (43) it is fed into cutting station (44). The cutting station (44) cuts the deformed sheet material into lengths. The cut lengths are transferred to stacking station (41). The cut lengths are stored in stacking station (41) until required to form a reflector support module.

A third decoiler (45) holds coils of 1800 mm wide, 1.6 mm thick, 300 MPA galvanised steel sheets (not shown).

The sheets are continuously fed into roll former (46).

The roll former (46) manipulates the sheets of material to create the first complementary surface (19) and second complementary surface (24).

As the sheets of material exit third roll former (46) they are fed into press (47).

The press (47) forms apertures (27) in the sheet material, collars (28) and curves (28B) and flanges (35). As the sheets exit press (47) they enter second cutting station (48). The second cutting station (48) cuts the sheets to length. The cut sheets are transferred to stacking station (50) where they are stored until required.

A first support arm (14) and a second support arm (31) are fed into a crimp press (49) and orientated so that the first complementary surfaces (19) of support arms (14, 31) overlap and contact each other.

The crimp press (49) is engaged so as to deform the complementary surfaces (19) and thereby secure the first support arm (14) and second support arm (31) together.

The secured support arms (14, 31) are moved into a second crimp press (51).

The crimp press (51) includes pairs of crimping elements (not visible). The pairs of crimping elements are engaged to move towards each other from opposite sides of the sheets. The crimp press (51) forces the pairs of crimping elements together and applies sufficient force to deform the first and second sheets (3, 4) at those points where they meet.

The crimp press (51) is disengaged and crimping elements move away from each other. The sheets of material and/or crimping elements are repositioned with respect to each other. The crimp press (51) is again engaged to cause crimping elements to move towards each other and thereby deform the sheets of material (3, 4) at points where they contact each other that may not have already been deformed.

The above process may be repeated so as to ensure that the sheets of material (3, 4) are secured together at all of the points where they contact.

The reflector support deck (2) is positioned so as to bear against second complementary surfaces (24).

The third crimping press is engaged to deform the second sheet of material and second mating surfaces (25). This secures the reflector support deck (8) to the first and second support arms (14, 31). Constructing a Reflector Support

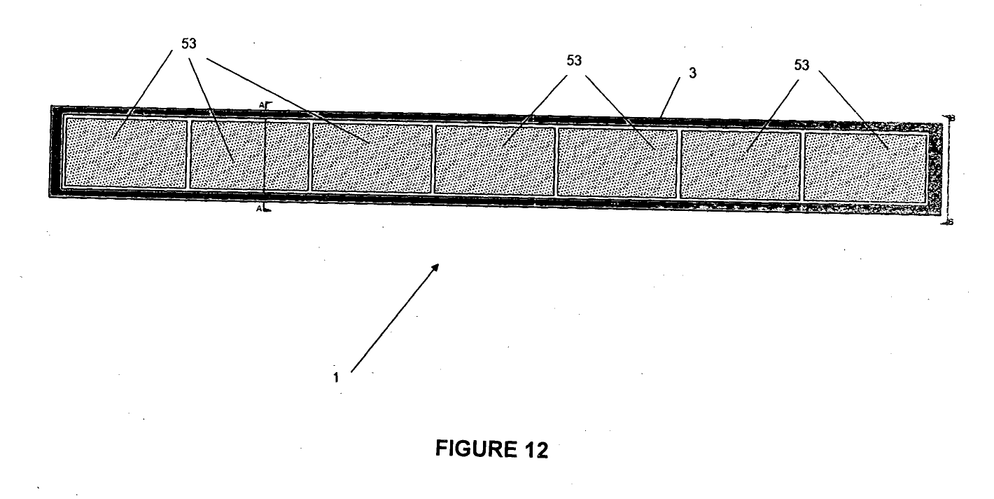

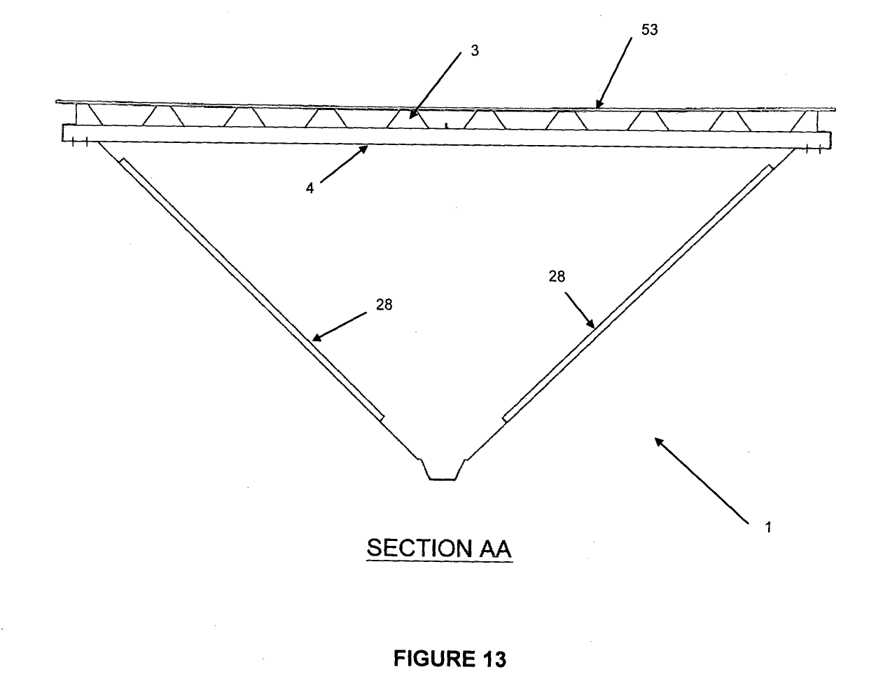

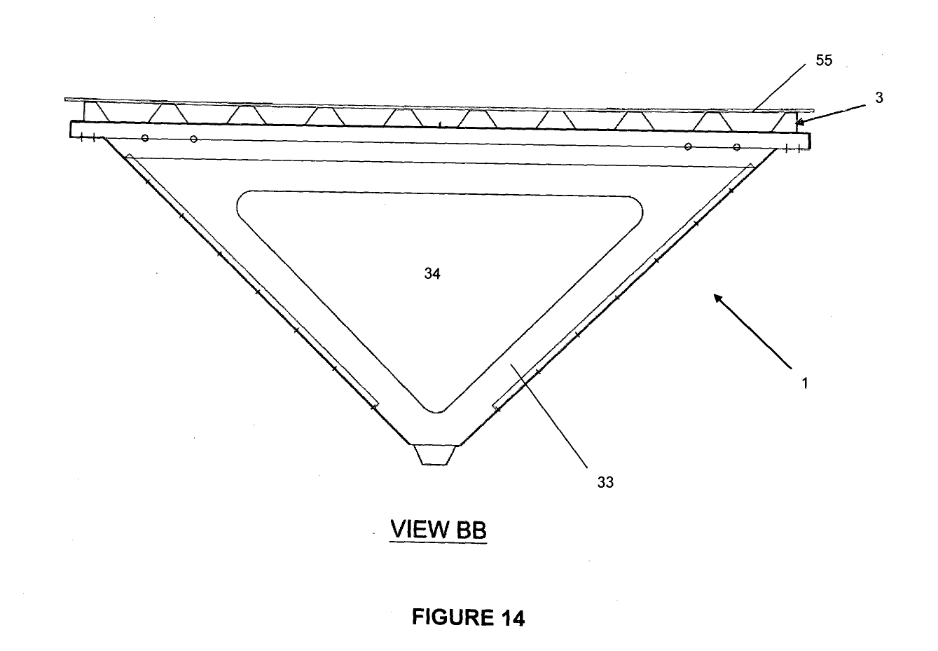

Referring now to FIGS. 12, 13, and 14 showing an assembled reflector support constructed using reflector support modules (1A-1C) to form an LFR (not shown).

Reflector support modules (1A-1C) are packed into standard shipping containers. In doing so, the reflector support modules (1A-1C) are nested together so as to create substantially triangular shapes. The triangular shape of the reflector support modules (1A-1C) enables efficient packing in the shipping containers.

The shipping containers can be easily transported to the site where a LFR is to be constructed.

The reflector support modules (1A-1C) are removed from shipping containers.

A reflector support module (1A) having a length of substantially 12 metres is placed in a clear site.

A reflector support module (1B) having a length of substantially 5 metres is positioned relative to the reflector support module (1A).

The end (56) of reflector support module (1B) is positioned so as to abut end (57) of reflector support module (1A). In doing so, the lengths of the reflector support modules (1A, 1B) are substantially aligned.

In addition, flanges (35) are aligned with each other.

Fasteners (not shown) are inserted through the flanges (35) to secure the reflector support modules together.

A reflector support module (1C) can be positioned so that its end (4958 is adjacent to end (59) of reflector support module (1A). In doing so, the lengths of reflector support modules (1A, 1C) are substantially aligned. In addition, flanges (35) are aligned.

Fasteners (not shown) are inserted through flanges (35) to thereby secure the reflector support modules (1A, 1B) together.

End caps (33) are secured to ends (60, 61) of reflector modules (1B, 1C).

This is achieved by using fasteners (not shown) which extend through flanges (not visible) on reflector modules (1B, 1C) and end caps (33).

An axle (not shown) is secured to reflector support (1). The axles extend beyond ends of reflector support modules (1B, 1C). The axles are configured to be engaged by actuators in a LFR reflector arrays (not shown).

Reflectors (55) are secured to crests (9) using adhesives or fasteners as should be known to one skilled in the art.

The crests (9) provide a curved bearing surface to support reflectors (55) along the length.

The axles and reflectors are as should be understood by one skilled in the art.

Aspects of the present invention have been described by way of example only and it should be appreciated that modifications and additions may be made thereto without departing from the scope thereof as defined in the appended claims.

1-28. (canceled)

29. A reflector support deck for a Linear Fresnal Reflector power station, including at least one corrugated sheet of material having two or more ridges of differing heights,
wherein the ridges are positioned relative to each other so that the crests of the ridges collectively define a curved bearing surface that curves along a single axis.

30. The reflector support deck as claimed in claim 29, wherein one or more of the ridges have a substantially trapezoidal cross section.

31. The reflector support deck as claimed in claim 29, wherein one or more of the crests are curved.

32. The reflector support deck as claimed in claim 29, wherein one or more of the ridges has a constant cross section along its length.

33. The reflector support deck as claimed in claim 29, including a second sheet of material secured to the corrugated sheet of material.

34. The reflector support deck as claimed in claim 33, wherein the second sheet of material is a corrugated sheet of material having two or more ridges.

35. The reflector support deck as claimed in claim 34, wherein the two or more ridges on the second sheet of material have a substantially trapezoidal cross section.

36. The reflector support deck as claimed in claim 34, wherein:
the troughs of ridges on the first corrugated sheet bear against crests of ridges on the second corrugated sheet; and
wherein the first and second corrugated sheets are crimped together at the points where the troughs bear against the crest.

37. The reflector support deck as claimed in claim 29, wherein the sheet is made from galvanized steel.

38. The reflector support deck as claimed in claim 37, wherein the galvanized steel is selected from the grades 200 MPA-600 MPA.

39. A reflector support, including
a. at least one corrugated sheet of material having two or more ridges of differing heights, and wherein at least one of the ridges has a substantially trapezoidal cross section, and
b. a reflector secured to the at least one corrugated sheet.

40. The reflector support as claimed in claim 39, wherein the ridges are positioned relative to each other so that crests of the ridges collectively define a bearing surface that extends along a single axis.

41. The reflector support as claimed in claim 40, wherein one or more of the crests are curved.

42. The reflector support as claimed in claim 39, wherein one or more of the ridges has a constant cross section along its length.

43. The reflector support as claimed in claim 41, wherein the curved crests have a radius in the range of 20-50 metres.

44. The reflector support as claimed in claim 39, including a second sheet of material secured to the corrugated sheet of material,
wherein the second sheet of material is a corrugated sheet of material having two or more ridges.

45. The reflector support as claimed in claim 44, wherein the two or more ridges on the second sheet of material have a substantially trapezoidal cross section.

46. The reflector support as claimed in claim 44, wherein the crests and troughs of the ridges on the second sheet are positioned substantially parallel to each other.

47. The reflector support as claimed in claim 44, wherein the troughs of ridges on the first corrugated sheet bear against crests of ridges on the second corrugated sheet.

48. The reflector support as claimed in claim 44, wherein the troughs of ridges on the first corrugated sheet bear against crests of ridges on the second corrugated sheet, wherein the first and second corrugated sheets are crimped together at the points where the troughs bear against the crest.

49. The reflector support as claimed in claim 40, wherein the sheet is made from galvanized steel.

50. The reflector support as claimed in claim 49, wherein the galvanized steel is selected from the grades 200 MPA-600 MPA.
